(19) United States
(12) Patent Application Publication
(10) Pub. No.: US 2009/0051626 A1
(43) Pub. Date: Feb. 26, 2009

(54) DEVICE AND METHOD FOR CONTROLLING DISPLAY-PANEL-ADDRESSING ELECTRODES

(75) Inventors: Jean-Raphael Bezal, Meylan (FR); Gilles Troussel, Grenoble (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS SA, Montrouge (FR)

(21) Appl. No.: 12/043,631

(22) Filed: Mar. 6, 2008

(30) Foreign Application Priority Data
Mar. 8, 2007 (FR) 0753713

(51) Int. Cl. G09G 3/28; G09G 3/20

(52) U.S. Cl. 345/60; 345/55

(57) ABSTRACT

A method controls electrodes for addressing a display panel having pixels distributed in lines and in columns, each addressing electrode being associated with a column in the panel, each line in the panel being successively selected for the addressing of the pixels in the line. The method includes maintaining, at least for part of the selection of each line, of at least one addressing electrode at a given reference voltage when the pixel of the line associated with the at least one addressing electrode is to be addressed, and setting to high impedance of the at least one addressing electrode between the successive selection of two lines having their pixels associated with the at least one addressing electrode which are to be addressed.

### TECHNICAL FIELD

The present disclosure generally relates to a device and a method for controlling electrodes of a display panel, especially but not exclusively of a plasma display panel, which are used during display panel addressing phases.

### BACKGROUND INFORMATION

A memory-effect A.C. plasma display panel generally comprises two parallel plates separated by a space containing a discharge gas. The plates are provided on their internal surfaces with electrode networks covered with a dielectric layer, which define image elements or pixels.

FIG. 1 schematically shows a portion of a plasma display panel in which the pixels are arranged in lines and in columns. As an example, four pixels Pix_{m,n}; Pix_{m,n+1}; Pix_{m+1,n}; and Pix_{m+1,n+1} of two adjacent lines Lineₘ and Lineₘ₊₁ and of two adjacent columns Columnₙ and Columnₙ₊₁ have been shown, where n is an integer varying from 1 to N and m is an integer varying from 1 to M. In the following description, a reference with no index is used to designate an electronic component or an element in general or all the electronic components or elements of a same type and a reference provided with an index is used to designate a specific electronic component or a specific element. With each column is associated a column electrode Ec and with each line is associated a line scan electrode Els and a common line electrode Elcom.

All common line electrodes Elcom are connected to a same voltage source Com. Each line scan electrode Els is associated with a line electrode control circuit comprising, for example, a first switch Tlh capable of connecting line scan electrode Els to a high line reference voltage Vscan and a second switch Tll capable of connecting line scan electrode Els to a low line reference voltage Vbw. Each column electrode Ec is associated with a column electrode control circuit comprising, for example, a first switch Tdh capable of connecting column electrode Ec to a high column reference voltage Vpp and a second switch Tdl capable of connecting column electrode Ec to a low column reference voltage, for example, ground GND.

When the plasma panel is in operation, to display an image, a succession of scannings, or even of sub-scannings, of the pixel array is performed to activate or not certain array pixels. Each scanning or sub-scanning for example comprises the following steps:
first, a selective addressing step which aims at depositing electric charges on the dielectric layer portion at the level of the pixels to be activated, by application of at least one voltage pulse between the column electrodes Ec and the line scan electrodes Els which cross at the level of such pixels; and
then, a non-selective sustain step during which a succession of voltage pulses are applied, for each line, between line scan electrode Els and common line electrode Elcom to cause a succession of light discharges only at the level of the line pixels which have been previously addressed.

More specifically, in an addressing phase, the lines are successively addressed by placing the corresponding line scan electrode Els at voltage Vbw, the other line electrodes being maintained at voltage Vscan. For each selected line, the column electrodes Ec of the columns for which the pixels of the selected line are desired to be addressed are set to voltage Vpp, the other column electrodes being maintained at ground GND.

The panel is seen by each electrode as a capacitor which is charged or discharged in addressing and sustain steps at high voltages and frequencies. As an example, the high reference voltages of the column electrodes are generally greater than 50 volts and the addressing frequencies are generally greater than 100 kilohertz. A disadvantage of previously-described circuits for controlling column electrodes Ec is that the power lost at column electrodes Ec by the panel, which may exceed 100 watts, is essentially dissipated in the switches of the column electrode control circuits. It may be difficult to efficiently carry off the generated heat, in particular when the switches of the column electrode control circuits are made in integrated form.

To decrease power losses, a column electrode control circuit based on a resonant circuit where, for each column electrode Ec, the capacitor representative of the panel capacitance is put in resonance with an inductance around a given voltage, may be used. Theoretically, a resonant control circuit enables decreasing power losses on addressing of the column electrodes with respect to the column electrode control circuits shown in FIG. 1.

However, with certain resonant control circuits, a decrease in power losses is actually only obtained for the display of images for which the pixels to be addressed and not to be addressed in the panel are relatively equally distributed. Such resonant control circuits may even result in power losses greater than those obtained with the control circuits of FIG. 1, especially when the image almost only comprises pixels to be addressed. Indeed, in this case, many column electrodes must be maintained at high column reference voltage Vpp during the successive selection of several panel lines and the operation of some resonant control circuits imposes for these column electrodes to vary from Vpp to 0 volt, then from 0 volt to Vpp for each selection of a new line, which translates as power losses.

### BRIEF SUMMARY

Embodiments provide a device and a method for controlling control electrodes of a display panel, especially a plasma panel, enabling decreasing power losses in panel addressing.

According to one embodiment, the control device comprises a decreased number of components.

One embodiment provides a method for controlling electrodes for addressing a display panel comprising pixels distributed in lines and in columns, each addressing electrode being associated with a column in the panel, each line in the panel being successively selected for the addressing of the pixels in the line, the method comprising the maintaining, at least for part of the selection of each line, of at least one addressing electrode at a given reference voltage when the pixel of the line associated with said at least one addressing electrode is to be addressed, and the setting to high impedance of said at least one addressing electrode between the successive selection of two lines having their pixels associated with said at least one addressing electrode which are to be addressed.

According to an embodiment, said at least one addressing electrode is connected to a node via a switch, the method comprising bringing, before selection of each line, the node at least from an additional reference voltage to said given reference voltage; maintaining the node at said given reference voltage during the line selection, the switch being on for at least part of the selection of the line to connect said at least one addressing electrode to the node when the pixel of the line associated with said at least one addressing electrode is to be addressed; and turning off the switch between the successive selection of two lines having their pixels associated with said at least one addressing electrode which are to be addressed to set said at least one addressing electrode to high impedance.

One embodiment also provides a device for controlling electrodes for addressing a display panel comprising pixels distributed in lines and in columns, each addressing electrode being associated with a column in the panel, each line in the panel being successively selected for the addressing of the pixels in the line, the device comprising means for maintaining, at least for part of the selection of each line, at least one addressing electrode at a given reference voltage when the pixel of the line associated with said at least one addressing electrode is to be addressed; and means for setting to high impedance said at least one addressing electrode between the successive selection of two lines having their pixels associated with said at least one addressing electrode which are to be addressed.

According to an embodiment, said at least one addressing electrode is connected to a node via a switch, the device further comprising a circuit designed for, before selection of each line, bringing the node at least from an additional reference voltage to said given reference voltage and maintaining the node at said given reference voltage during the line selection; means for controlling the turning-on of the switch for at least part of the selection of the line to connect said at least one addressing electrode to the node when the pixel of the line associated with said at least one addressing electrode is to be addressed; and means for controlling the turning-off of the switch between the successive selection of two lines having their pixels associated with said at least one addressing electrode which are to be addressed, to set said at least one addressing electrode to high impedance.

According to an embodiment, the switch comprises a first MOS transistor comprising a first power terminal connected to the node and a second power terminal, the bulk of the first transistor being connected to said second power terminal, and a second MOS transistor comprising a third power terminal connected to the second power terminal and a fourth power terminal connected to said at least one addressing electrode, the bulk of the second MOS transistor being connected to the third power terminal.

According to an embodiment, the gates of the first and second transistors are connected in common.

According to an embodiment, the device comprises a resonant circuit comprising a source of another additional reference voltage connected to the node via an inductance.

According to an embodiment, said at least one addressing electrode is connected to a source of the additional reference voltage via an additional switch.

The foregoing and other features will be discussed in detail in the following non-limiting and non-exhaustive description of specific embodiments in connection with the accompanying drawings.

### BRIEF DESCRIPTION OF THE SEVERAL VIEWS OF THE DRAWINGS

FIG. 1, previously described, schematically shows an example of conventional circuits for controlling the line and column electrodes associated with four adjacent pixels of a plasma display panel;

FIG. 2 shows an example of a circuit for controlling column electrodes of a plasma display panel;

FIG. 3 shows an example of a timing diagram of signals representative of an example of a control method of the control circuit of FIG. 2 which is not optimal to decrease power losses;

FIG. 4 shows an example of a timing diagram of signals representative of another example of a control method of the control circuit of FIG. 2 enabling decreasing power losses;

FIG. 5 shows a more detailed example of one embodiment of a switch of the circuit of FIG. 2;

FIG. 6 shows another more detailed example of one embodiment of a switch of the circuit of FIG. 2; and

FIG. 7 shows an example of a system for controlling the switch of the circuit of FIG. 6, according to one embodiment.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

For clarity, the same elements have been designated with the same reference numerals in the different drawings.

FIG. 2 shows an embodiment of a circuit 10 for controlling column electrodes Ec of a plasma panel based on a resonant circuit and enabling decreasing power losses.

Control circuit 10 comprises a common control circuit 12 which is, generally, connected to an optimum number of column electrodes. As an example, only two column electrodes Ecₙ and Ecₙ₊₁ have been shown in FIG. 2. With each column electrode Ec is associated a capacitor C having a capacitance equivalent to all the panel capacitances as seen from electrode Ec. Note that Vc is the voltage applied across capacitor C. Common control circuit 12 comprises a capacitor C1 having a terminal connected to ground GND and its other terminal connected to node K. Node K is connected to a node D via a switch Tdown in series with a diode D1, the anode of diode D1 being connected to node D. Node K is, further, connected to node D via a switch Tup in series with a diode D2, the cathode of diode D2 being connected to node D. Node D is connected to ground GND via a diode D3, the cathode of diode D3 being connected to node D. Node D is connected to a source of voltage Vpp via a diode D4, the anode of diode D4 being connected to node D. An inductance L is arranged between node D and a node E. Note that I_{L} is the current flowing through inductance L, the current being positive when it flows from node D to node E. Note that V_{E} is the potential difference between node E and ground GND. Node E is connected to ground GND via a switch Trl and is connected to the source of voltage Vpp via a switch Trh.

Circuit 10 comprises, for each column electrode Ec, a dedicated circuit 14 comprising a switch Tdh capable of connecting column electrode Ec to node E and a switch Tdl capable of connecting column electrode Ec to ground GND.

Capacitor C1 is charged up to voltage Vpp/2. The operating principle of circuit 10 is to have, for each column electrode Ec, capacitor C representative of the capacitance of the panel as seen from column electrode Ec resonate with inductance L around the voltage across capacitor C1. The voltage across capacitor C1 is automatically maintained substantially at Vpp/2 by the power transfers occurring on operation of control circuit 10.

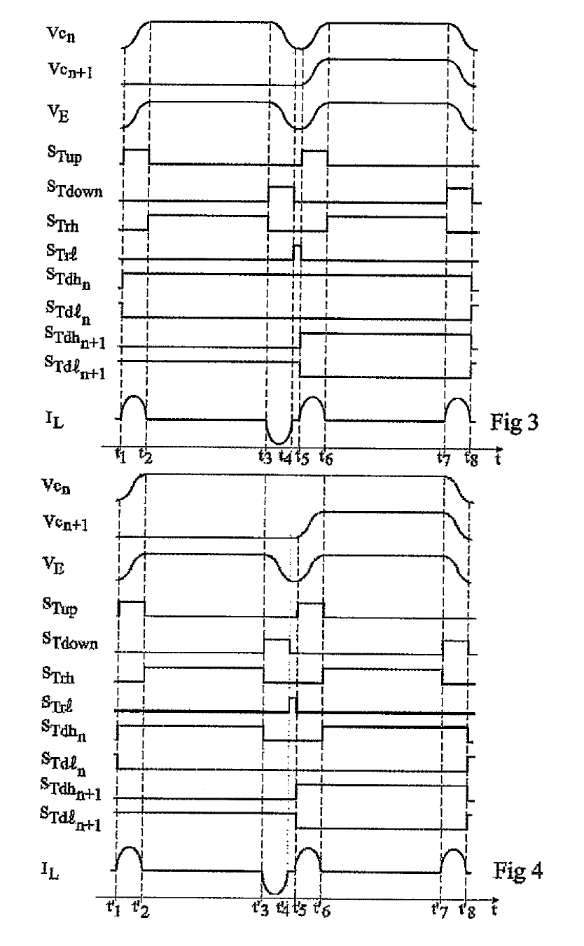

FIG. 3 shows an example of a timing diagram of characteristic signals of control circuit 10 of FIG. 2 for an example embodiment of a method for controlling column electrodes Ecₙ, Ecₙ₊₁, on successive selection of a first panel line and of a second panel line, which does not enable optimizing the decrease in power losses in the case where a majority of the panel pixels are to be addressed. Note S_{Tup}, ST^{down}, S_{Trh}, S_{Trl}, S_{Tdhn}, S_{Tdln}, S_{Tdln+1}, and S_{Tdln+1} the respective control signals of switches Tup, Tdown, Trh, Trl, Tdhlₙ, Tdlₙ, Tdhₙ₊₁, and Tdlₙ₊₁. As an example, a switch is on when the corresponding control signal is in a high state and off when the corresponding control signal is in a low state, where the low and high states of the control signals can be different. Note tᵢ, with i varying from 1 to 8, successive times.

In the present example, it is desired to only address the pixel associated with column electrode Ecₙ₊₁ on selection of the first line, and it is desired to only address the pixel associated with column electrodes Ecₙ and Ecₙ₊₁ on selection of the second line.

At time t₁, switches Tdhₙ and Tdlₙ₊₁ are on and switches Tdlₙ and Tdhₙ₊₁ are off, given that it is only desired to address the pixel associated with column electrode Ecₙ. The addressing step starts with the turning-on of switch Tup, switches Trh, Trl, and Tdown being off. A positive current I_{L} flows through inductance L, causing a rise in voltage V_{E} from 0 volt up to Vpp. A rise in voltage Vcₙ from 0 to Vpp is thus obtained while voltage Vcₙ₊₁ is maintained at 0 volt.

At time t₂, current I_{L} cancels when voltage V_{E} has almost reached Vpp. Diode D2 then prevents the flowing of a negative current I_{L}. Diode D4 enables avoiding a discontinuity in the current when D2 cuts off the current by maintaining the voltage of node D at Vpp. Switch Tup is then turned off. Voltage V_{E} is maintained at Vpp by turning on switch Trh.

At time t₃, corresponding to the end of the addressing of the pixel of the first line associated with column electrode Ecₙ, switch Trh is turned off and switch Tdown is turned on. A negative current I_{L} then flows through inductance L, causing a decrease in voltage V_{E} from Vpp to 0 volt. Switch Tdhₙ being on, voltage Vcₙ also decreases from Vpp to 0 volt. Switch Tdlₙ₊₁ being on, voltage Vcₙ₊₁ is maintained at 0 volt.

At time t₄, when voltage V_{E} has almost reached 0 volt, current I_{L} cancels. Diode D1 prevents the flowing of a positive current I_{L}. Diode D3 enables avoiding a discontinuity in the current when D1 cuts off the current by maintaining the voltage at node D at 0 volt. Switch Tdown is turned on and switch Trl is turned off to maintain voltage V_{E} at 0 volt.

At time t₅, switch Tdhₙ is maintained on and switch Tdlₙ is maintained off given that, on selection of the second line, the corresponding pixel associated with column electrode Ecₙ is to be addressed. Further, switch Tdhₙ₊₁ is turned on and switch Tdlₙ₊₁ is turned off given that, on selection of the second line, the pixel associated with column electrode Ecₙ₊₁ is to be addressed.

At times t₅ and t₆, on selection of the second line, switches Tup and Trh are successively turned on as previously described for times t₁ and t₂. Since switches Tdhₙ and Tdhₙ₊₁ are turned on, voltages Vcₙ and Vcₙ₊₁ increase from 0 volt to Vpp. Finally, at the end of the addressing of the pixels of the second line, from time t₇ to time t₈, switch Tdown is turned on to lower voltage V_{E} from Vpp to 0 volt.

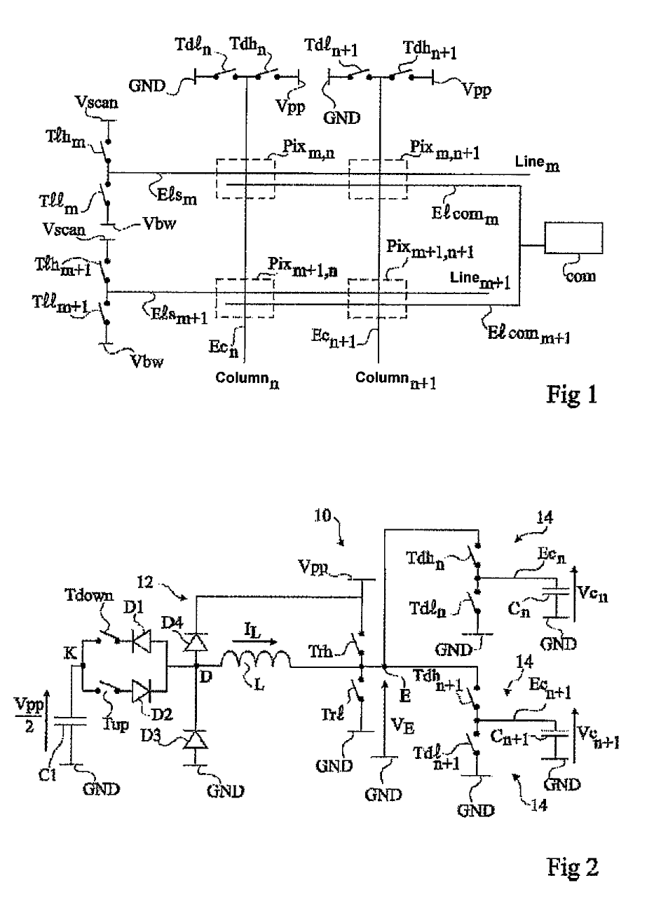

The previously-described method for controlling circuit 10 is advantageous for the display of an image in which the pixels of a same column associated with two successively-selected lines are in different states (addressed or non-addressed state). The power lost on addressing of the pixels is then lower than that lost by the column electrode control circuits shown in FIG. 1. However, the previously-described method for controlling circuit 10 is not advantageous as soon as there is a significant number of pixels of same columns which are addressed for several successively-selected lines, which is the case, for example, for uniform images. In this case, power losses greater than the losses obtained with the column electrode control circuits shown in FIG. 1 are even obtained since the column electrodes associated with pixels addressed for two successively selected lines vary from Vpp to 0, then from 0 to Vpp for nothing.

One embodiment comprises, when the pixels associated with a same column electrode are to be addressed on successive selection of first and second lines, maintaining the column electrode at high impedance during the transition phase, between the end of the selection of the first line and the beginning of the selection of the second line, during which voltage V_{E} successively varies from Vpp to 0 volt, then from 0 volt to Vpp. This enables maintaining the column electrode substantially at Vpp and thus decreasing power losses with respect to the control method of circuit 10 previously described in relation with FIG. 3.

FIG. 4 shows an example of a timing diagram of signals characteristic of control circuit 10 of FIG. 2 for another example embodiment of a method for controlling column electrodes Ecₙ, Ecₙ₊₁ which enables obtaining such a decrease in power losses. The conventions used for FIG. 3 are kept. In the present example, it is desired to only address the pixel associated with column electrode Ecₙ on selection of the first line and it is desired to address the pixels associated with column electrodes Ecₙ and Ecₙ₊₁ on selection of the second line. Note t′ᵢ, with i varying from 1 to 8, successive times.

Between times t′₁ and t′₈, switches Tdlₙ, Tdhₙ₊₁, Tdlₙ₊₁, Tup, Tdown, Trh, and Trl are controlled identically to what has been previously described between times t₁ and t₈ in relation with FIG. 3. Switch Tdhₙ is controlled, at times t′₁ and t′₂, identically to what has been previously described at times t₁ and t₂ in relation with FIG. 3.

At time t′₃, corresponding to the end of the addressing of the pixel of the first line associated with column electrode Ecₙ, switch Tdhₙ is turned off. Column electrode Ecₙ is then maintained at high impedance. Voltage Vcₙ thus varies little and remains substantially equal to Vpp.

Switch Tdhₙ is maintained off until time t′₆, that is, for the entire transition phase during which voltage V_{E} switches from Vpp to 0 volt, then from 0 volt to Vpp.

At time t′6, switch Tdhₙ is on. Since switch Trh is also on, column electrode Ecₙ is then maintained at Vpp.

Switch Tdhₙ is controlled, at times t′₇ and t′₈, identically to what has been previously described at times t₇ and t₈ in relation with FIG. 3.

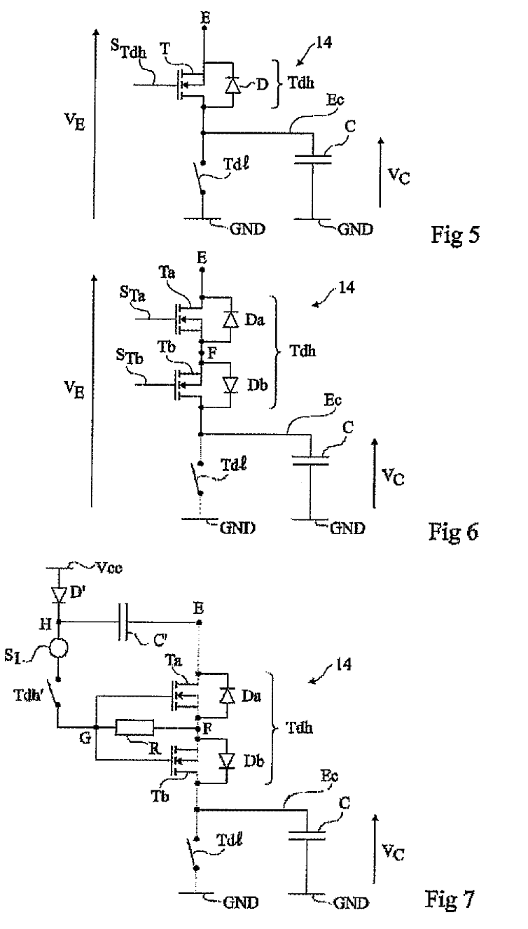

FIG. 5 shows a more detailed embodiment of the dedicated circuit 14 of a column electrode Ec. Switch Tdh is formed of a single N-channel MOS transistor T having its drain connected to node E, having its source connected to column electrode Ec, and having its bulk connected to the source of transistor T. The gate of transistor T is capable of receiving control signal S_{Tdh}. A diode D assembled in parallel between the drain and the source of transistor T has been shown, the cathode of diode D being connected to the drain of transistor T. Diode D corresponds to the “parasitic” diode between the drain and the substrate of transistor T. Such an embodiment of switch Tdh does not enable implementing the control method of circuit 10 previously described in relation with FIG. 4. Indeed, when transistor T is off between times t′₃ and t′₆ to maintain column electrode Ec at high impedance while switch Tdl is itself off, and when voltage V_{C} is substantially equal to Vpp and voltage V_{E} decreases from Vpp to 0 volt, a leakage current tends to flow from ground GND to node E via column electrode Ec and diode D. A decrease in voltage V_{C} can thus be observed, which is not desirable.

FIG. 6 shows another more detailed embodiment of dedicated circuit 14 of a column electrode Ec adapted to the implementation of the control method of circuit 10 previously described in relation with FIG. 4. Switch Tdh is formed of two N-channel MOS transistors Ta and Tb in series. A first power terminal of transistor Ta is connected to node E and the second power terminal of transistor Ta is connected to a node F. A first power terminal of transistor Tb is connected to node F and the second power terminal of transistor Tb is connected to column electrode Ec. The substrates of transistors Ta and Tb are connected to node F. The gate of transistor Ta is capable of receiving a control signal S_{Ta} and the gate of transistor Tb is capable of a receiving a control signal S_{Tb}. Control signals S_{Ta} and S_{Tb} may both be equal to previously-described control signal S_{Tdh}. In other words, both switches Ta and Tb are simultaneously off or on.

A diode Da assembled in parallel across transistor Ta has been shown, the cathode of diode Da being connected to node E. Diode Da corresponds to the “parasitic” diode between the first power terminal and the substrate of transistor Ta. A diode Db assembled in parallel across transistor Tb has further been shown, the cathode of diode Db being connected to column electrode Ec. Diode Db corresponds to the “parasitic” diode between the second power terminal and the substrate of transistor Tb.

The fact for the cathode of diode Db to be connected to column electrode Ec prevents the flowing of a leakage current from ground GND to node E when both transistors Ta and Tb are off while switch Tdl is off, when voltage V_{C} is substantially equal to Vpp and voltage V_{E} decreases from Vpp to 0 volt.

FIG. 7 shows an embodiment of the control of transistors Ta and Tb of FIG. 6. The gates of transistors Ta and Tb are connected to a node G. A resistor R is arranged between nodes G and F. A switch Tdh′ and a current source Si are arranged in series between node G and a node H. A capacitor C′ is arranged between nodes H and E. A diode D′ connects node H to a source of a reference voltage Vcc, which is for example of a few volts, the cathode of diode D′ being connected to node H. The control signal of switch Tdh′ is equal to previously-described signal S_{Tdh}. When switch Tdh′ is on, a current flows through resistor R, imposing a positive potential difference between nodes G and F and thus the application of a positive gate voltage to the gate of transistors Ta and Tb which are then on. Capacitor C′ maintains the voltage at node H permanently at a greater level than the voltage at node E to ensure a proper biasing of the gates of transistors Ta, Tb. Indeed, when node E is at 0 volt, capacitor C′ is charged by the source of reference voltage Vcc and the voltage at node H slightly rises with respect to the voltage at node E. After, when the voltage at node E increases, the voltage at node H also increases by coupling effect due to capacitor C′.

When switch Tdh′ is off, the voltage at the gates of transistors Ta and Tb is zero. Said transistors are thus on.

Specific embodiments have been described. Various alterations and modifications may be provided. In particular, although one embodiment has been described for a specific structure of resonant control circuits 10, it should be clear that it can apply to other resonant control circuit structures and even to circuits other than resonant control circuits. Indeed, one embodiment applies to any control circuit capable of varying voltage V_{E}, to which are connected column electrodes Ec via the associated switch Tdh, between a low reference voltage and a high reference voltage, and for which voltage V_{E} varies during the transition phase between the end of the selection of a line and the beginning of the selection of another line in the panel.

Such alterations, modifications, and improvements are intended to be part of this disclosure, and are intended to be within the spirit and the scope of the embodiment(s). Accordingly, the foregoing description is by way of example only and is not intended to be limiting.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method for controlling electrodes addressing a display panel having pixels distributed in lines and in columns, each addressing electrode being associated with a column in the panel, each line in the panel being successively selected for addressing of the pixels in the line, the method comprising:
maintaining, at least for part of a selection of each line, at least one addressing electrode at a reference voltage when a pixel of the line associated with said at least one addressing electrode is to be addressed; and
setting to high impedance said at least one addressing electrode between successive selection of two lines having their pixels associated with said at least one addressing electrode which are to be addressed.

2. The method of claim 1 wherein said at least one addressing electrode is coupled to a node via a switch, the method comprising:
bringing, before selection of each line, the node at least from an additional reference voltage to said reference voltage;
maintaining the node at said reference voltage during the line selection, the switch being on for at least part of the selection of the line to couple said at least one addressing electrode to the node when the pixel of the line associated with said at least one addressing electrode is to be addressed; and
turning off the switch between the successive selection of two lines having their pixels associated with said at least one addressing electrode which are to be addressed to set said at least one addressing electrode to high impedance.

3. A device for controlling electrodes addressing a display panel having pixels distributed in lines and in columns, each addressing electrode being associated with a column in the panel, each line in the panel being successively selected for addressing of the pixels in the line, the device comprising:
means for maintaining, at least for part of a selection of each line, at least one addressing electrode at a reference voltage when a pixel of the line associated with said at least one addressing electrode is to be addressed; and
means for setting to high impedance said at least one addressing electrode between successive selection of two lines having their pixels associated with said at least one addressing electrode which are to be addressed.

4. The control device of claim 3 wherein said at least one addressing electrode is coupled to a node via a switch, the device further comprising:
a circuit designed for, before selection of each line, bringing the node at least from an additional reference voltage to said reference voltage and maintaining the node at said reference voltage during the line selection;
means for controlling turning-on of the switch for at least part of the selection of the line to couple said at least one addressing electrode to the node when the pixel of the line associated with said at least one addressing electrode is to be addressed; and
means for controlling turning-off of the switch between the successive selection of two lines having their pixels associated with said at least one addressing electrode which are to be addressed, to set said at least one addressing electrode to high impedance.

5. The device of claim 4 wherein the switch includes a first transistor having a first power terminal coupled to the node and a second power terminal, a bulk of the first transistor being coupled to said second power terminal, and a second transistor having a third power terminal coupled to the second power terminal and a fourth power terminal coupled to said at least one addressing electrode, a bulk of the second MOS transistor being coupled to the third power terminal.

6. The device of claim 5 wherein gates of the first and second transistors are coupled in common.

7. The device of claim 4 wherein said circuit includes a resonant circuit having a source of another additional reference voltage coupled to the node via an inductance.

8. The device of claim 4 wherein said at least one addressing electrode is coupled to a source of the additional reference voltage via an additional switch.

9. A system, comprising:
a display panel having pixels distributed in lines and in columns, and having address electrodes each associated with a column in the panel, each line in the panel being successively selectable to address the pixels in the line; and
a circuit coupled to said display panel and adapted to maintain, at least for part of a selection of each line, at least one address electrode at a reference voltage if a pixel of the line associated with said at least one address electrode is to be addressed, and adapted to set to high impedance said at least one address electrode between successive selection of two lines having their pixels, associated with said at least one address electrode, which are to be addressed.

10. The system of claim 9 wherein said circuit includes:
a first switch to couple said at least one address electrode to a first node; and
a second switch to couple said at least one address electrode to ground.

11. The system of claim 10 wherein said first switch includes:
a first transistor having a first terminal coupled to said first node, a second terminal coupled to a second node, and a third terminal to receive a first control signal; and
a second transistor having a first terminal coupled to said at least one address electrode, a second terminal coupled to said second node, and a third terminal to receive a third control signal.

12. The system of claim 11 wherein said circuit further includes:
a third switch having a first terminal coupled to a first terminal of a current source and having a second terminal;
a resistor having a first terminal coupled to said second terminal of said third switch and to said third terminals of said first and second transistors, and having a second terminal coupled to said second node;
a first capacitor coupled between a second terminal of said current source and said first node; and
a second capacitor having a first terminal coupled to said first terminal of said second switch and having a second terminal coupled to ground.

13. The system of claim 11 wherein said first and second transistors include MOS transistors.

14. The system of claim 9 wherein said display panel includes a plasma display panel.

15. The system of claim 9 wherein said circuit includes a resonant circuit adapted to provide another reference voltage coupled to said first node via an inductor.

16. An apparatus to electrodes that address a display panel, the apparatus comprising:
a first transistor having a first terminal coupled to a first node, a second terminal coupled to a second node, and a third terminal to receive a first control signal;
a second transistor having a first terminal coupled to at least one of said address electrodes, a second terminal coupled to said second node, and a third terminal to receive a third control signal;
wherein said first and second transistors are adapted to maintain said at least one address electrode at a high impedance between an end of selection of a first line associated with said at least one address electrode and a beginning of selection of a second line associated with said at least one address electrode;
wherein said first and second transistors are further adapted to maintain said at least one address electrode at a reference voltage during at least part of said selection of said first and second lines; and
a first diode coupled to said second transistor and having a cathode coupled to said at least one address electrode, so that if said first and second control signals respectively turn off said first and second transistors, said first diode is adapted to prevent flow of leakage current from ground to said first node.

17. The apparatus of claim 16 wherein said first and second transistors form part of a first switch, the apparatus further comprising a second switch, coupled between said at least one address electrode and ground, adapted to couple said at least one address electrode to ground.

18. The apparatus of claim 16 wherein said first and second transistors are MOS transistors.

19. The apparatus of claim 16, further comprising:
a switch having a first terminal coupled to a first terminal of a current source and having a second terminal;
a resistor having a first terminal coupled to said second terminal of said switch and to said third terminals of said first and second transistors, and having a second terminal coupled to said second node;
a first capacitor coupled between a second terminal of said current source and said first node; and
a second capacitor having a first terminal coupled to said at least one address electrode and having a second terminal coupled to ground.

20. The apparatus of claim 16, further comprising a resonant circuit adapted to provide another reference voltage coupled to said first node via an inductor.
